(19) United States
(12) Patent Application Publication
(10) Pub. No.: US 2023/0391006 A1
(43) Pub. Date: Dec. 7, 2023

(54) ADDITIVE MANUFACTURING WITH SELECTING AN IRRADIATION MODULE

(71) Applicant: Hewlett-Packard Development Company, L.P., Spring, TX (US)

(72) Inventors: Krzysztof NAUKA, Palo Alto, CA (US); Esteve COMAS CESPEDES, Sant Cugat del Valles (ES)

(21) Appl. No.: 18/031,826

(22) PCT Filed: Oct. 16, 2020
(86) PCT No.: PCT/US2020/055967

§ 371 Date: Apr. 13, 2023

(51) Int. Cl. B29C 64/291; B29C 64/165; B29C 64/282

(52) U.S. Cl. CPC B29C 64/291; B29C 64/165; B29C 64/282; B33Y 30/00

(57) ABSTRACT

An additive manufacturing method includes: selecting one of a plurality of irradiation modules based on a selected module having a wavelength band tuned for absorption by a fusing agent to be used to form an object by additive manufacture; plugging the selected module into a socket over the build platform; supporting successive, stacked layers of the object being formed on the build platform; using a liquid dispenser mounted on the carriage, selectively dispensing the fusing agent into an uppermost layer of build material in a pattern corresponding to a layer of the object being formed; and fusing the build material by exposing the fusing agent to a first wavelength band from a first irradiation source in the selected module.

### BACKGROUND

The concept of additive manufacturing involves solidifying a build material according to a data specifying an object to be formed. In some additive manufacturing systems, the build material is in the form of a powder or liquid and is solidified layer-by-layer to build up the desired object. In powder-based systems, the powder may be heated to a preliminary temperature, selectively treated with a fusing agent based on a cross-section of the object being formed and irradiated to solidify or fuse the build material where the fusing agent was deposited.

### BRIEF DESCRIPTION OF THE DRAWINGS

The accompanying drawings illustrate various implementations of the principles described herein and are a part of the specification. The illustrated implementations are merely examples and do not limit the scope of the claims.

FIG. 1 is a block diagram of an illustrative additive manufacturing device or system, consistent with the disclosed implementations.

FIG. 2 is a flowchart showing an illustrative method of operating an additive manufacturing device, consistent with the disclosed implementations.

FIG. 3 is a flowchart showing additional aspects of an illustrative method of operating an additive manufacturing device, consistent with the disclosed implementations.

FIG. 4 is a block diagram of an illustrative additive manufacturing device or system, consistent with the disclosed implementations.

FIG. 5 is a block diagram of an illustrative additive manufacturing device or system, consistent with the disclosed implementations.

FIG. 6 is a chart showing absorption and emission profiles, consistent with the disclosed implementations.

FIG. 7 is a chart showing absorption and emission profiles, consistent with the disclosed implementations.

FIG. 8 is a chart showing absorption and emission profiles, consistent with the disclosed implementations.

FIG. 9 is a chart showing absorption and emission profiles, consistent with the disclosed implementations.

FIG. 10 is a chart showing absorption and emission profiles, consistent with the disclosed implementations.

FIG. 11 is a chart showing absorption and emission profiles, consistent with the disclosed implementations.

FIG. 12 is a block diagram of an illustrative additive manufacturing device or system, consistent with the disclosed implementations.

FIG. 13 is a block diagram of an illustrative additive manufacturing device or system, consistent with the disclosed implementations.

Throughout the drawings, identical reference numbers designate similar, but not necessarily identical, elements.

### DETAILED DESCRIPTION

As noted above, the concept of additive manufacturing involves solidifying a build material according to a data specifying an object to be formed. In powder-based systems, the powder may be initially pre-heated to a preliminary temperature, selectively treated with a fusing agent (FA) based on a cross-section of the object being formed and irradiated to solidify or fuse the build material where the fusing agent was deposited. After each layer or cross-section of the object has been formed, the excess, unsolidified build material is removed from around the object and recycled.

A variety of different materials can be used as the powdered build material, including plastics or polymers, ceramics and metals. Similarly, a variety of different fusing agents having different characteristics can be selected and used. Different build materials, fusing agents and build material/fusing agent combinations or sets will give the finished object different properties. For example, one material set might result in a structurally stronger object than other materials. A different material set may give more accuracy in fine details or a smoother finish in the finished object.

Thus, the user may want to select a different build material and/or fusing agent depending on what properties are most important in the finished object. However, different build materials and fusing agents may optimally need different parameters in the additive manufacturing system or method that are not readily adjusted in existing platforms. For example, the optimal build material or fusing agent may respond most effectively to a particular band of wavelengths that is different from the wavelengths an additive manufacturing system uses. Additionally, some build materials may be degraded by exposure to some doses of radiation that an additive manufacturing system uses for or is configured to use for a different build material. For these and other reasons, the user may want to control the wavelengths applied by the additive manufacturing system to optimally preheat the build material, fuse the fusing agent or avoid degradation to the build material.

Consequently, the present specification describes, for example, an additive manufacturing device that includes a build platform for supporting successive, stacked layers of an object being formed; a spreader for spreading successive layers of build material on the build platform; a liquid dispenser for selectively dispensing a liquid fusing agent into an uppermost layer of build material in a pattern corresponding to a layer of the object being formed; a carriage for moving the liquid dispenser over the build platform; a first irradiation source having a first wavelength band, the first wavelength band being tuned for absorption by the fusing agent; and a second irradiation source having a second wavelength band disposed above the build platform for heating the successive layers of build material on the build platform. In various examples, the first irradiation source may be on the carriage while the second irradiation source is stationary above the build platform. In other examples, both radiation sources may be stationary above the build platform or both on the carriage above and moving over the build platform. In this system, the first wavelength band does not overlap the second wavelength band. Additionally, in some examples, the second wavelength band has shorter wavelengths or is narrower than the first wavelength band.

This illustrative additive manufacturing device may further include a first plurality of irradiation modules, each module comprising an irradiation source. The carriage includes a socket to receive any of the first plurality of irradiation modules as the first irradiation source. In this example, each of the first plurality of irradiation modules has a wavelength band tuned to a different fusing agent. In some examples, each of the first plurality of irradiation modules comprises a Light Emitting Diode (LED) radiation source.

The additive manufacturing device of this example may further include a second plurality of irradiation modules. In this case, the second irradiation source comprises a socket to receive any of the second plurality of irradiation modules. Each of the second plurality of irradiation modules has a wavelength band tuned to a different build material.

In another example, the present specification describes an additive manufacturing method that includes: selecting one of a plurality of irradiation modules based on a selected module having a wavelength band tuned for absorption by a fusing agent to be used to form an object by additive manufacture; plugging the selected module into a socket over the build platform; supporting successive, stacked layers of the object being formed on the build platform; using a liquid dispenser mounted on the carriage, selectively dispensing the fusing agent into an uppermost layer of build material in a pattern corresponding to a layer of the object being formed; and fusing the build material by exposing the fusing agent to a first wavelength band from a first irradiation source in the selected module.

In still another example, the present specification describes an additive manufacturing device that includes a build platform for supporting successive, stacked layers of an object being formed; a spreader for spreading successive layers of build material on the build platform; a liquid dispenser for selectively dispensing a liquid fusing agent into an uppermost layer of build material in a pattern corresponding to a layer of the object being formed; a plurality of irradiation modules each comprising a radiation source with a wavelength band tuned for absorption by a different fusing agent; a carriage for moving the liquid dispenser over the build platform, wherein the carriage comprises a socket to receive any of the plurality of irradiation modules as a first irradiation source; and a second irradiation source disposed above the build platform for heating the successive layers of build material on the build platform.

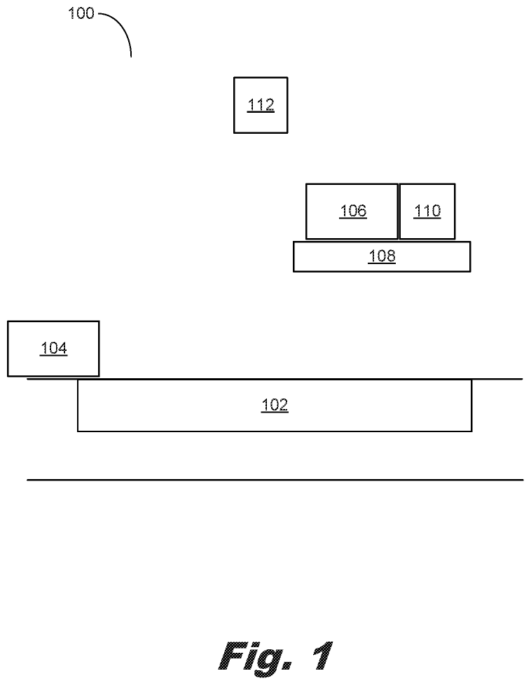

FIG. 1 is a block diagram of an illustrative additive manufacturing device 100 or system, consistent with the disclosed implementations. In this example, the additive manufacturing device 100 could use a variety of build materials, including a powdered material, a slurry or a liquid build material.

As shown in FIG. 1, the additive manufacturing device 100 includes a build platform 102 for supporting successive, stacked layers of an object being formed. A spreader 104 is arranged with the build platform 102 for spreading successive layers of build material on the build platform 102. The layers are stacked one on another as the entirety of the object is formed layer by layer. This spreader 104 may be, for example, a roller or blade for spreading a uniform layer of build material on the stack.

A liquid dispenser 106 is arranged for selectively dispensing a liquid fusing agent into an uppermost layer of build material in a pattern corresponding to a layer of the object being formed. A carriage 108 moves the liquid dispenser 106 over the build platform 102. As the carriage 108 reciprocates back and forth over the build platform 102, the liquid dispenser 106 is able to dispense fusing agent in any pattern on the uppermost layer of build material that corresponds to a cross-section of the object being formed for that layer of build material.

A first irradiation source 110 having a first wavelength band may be disposed on the carriage 108. This irradiation source 110 is operated to irradiate the layer of build material as treated with the fusing agent. The radiation from the irradiation source 110 causes the fusing agent to coalesce or solidify the build material into which the fusing agent has been applied. This may be because the fusing agent absorbs the radiation and generates heat that fuses the treated build material. In other examples. The radiation may trigger a chemical reaction between the fusing agent and the build material to coalesce or fuse the build material. In any case, the first wavelength band is tuned for absorption by the fusing agent.

A second irradiation source 112 having a second wavelength band may be disposed above the build platform 102 for heating the successive layers of build material on the build platform 102. This radiation source 112 is used for generally heating, usually pre-heating, each layer of build material to an optimal temperature for application of the fusing agent from the liquid dispenser 106. Thus, the second irradiation source 112 may be stationary and arranged in a position so as to heat the entire build platform 102.

In this example, the first wavelength band does not overlap the second wavelength band. Additionally, in some examples, the second wavelength band may have shorter wavelengths or be narrower than the first wavelength band. In other examples, the second wavelength band may have longer wavelengths or be broader than the first wavelength band

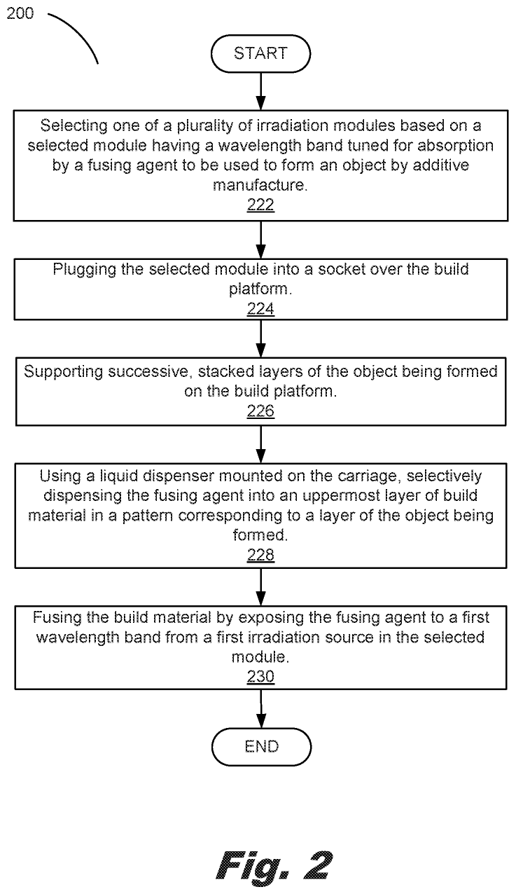

FIG. 2 is a flowchart showing an illustrative method 200 of operating an additive manufacturing device, consistent with the disclosed implementations. This additive manufacturing method 200 may expand the range of different fusing agents that can be readily used.

As shown in FIG. 2, the method includes selecting 222 one of a plurality of irradiation modules based on a selected module having a wavelength band tuned for absorption by a fusing agent to be used to form an object by additive manufacture. Accordingly, there will be multiple irradiation modules in a set, each emitting a different wavelength band. Thus, as the user selects different build materials that best suit a particular project, the user can also select a corresponding irradiation module that outputs a wavelength band that is tuned for absorption by a fusing agent that is to be used for the project at hand.

The method next includes plugging 224 the selected module into a socket over a build platform. For example, the module may be configured with prongs and is received by interference fit in a socket of the carriage without needing tools for installation. The module may be latched or otherwise secured to the carriage and will receive power from the carriage to emit the radiation for which it is designed. In some examples, the radiation modules will each include Light Emitting Diodes (LEDs) as a radiation source. The emitted radiation may be in different portions of the electromagnetic spectrum as is best tuned for absorption by a corresponding fusing agent. In some examples, the socket is in the carriage. The first irradiation source may thus be in the carriage and move relative to the build platform. In some examples, the socket is positioned over the build platform in a static location relative to the build platform.

After installation of the selected module, the method 200 includes supporting 226 successive, stacked layers of the object being formed on the build platform and, using a liquid dispenser mounted on the carriage, selectively dispensing 228 the fusing agent into an uppermost layer of build material in a pattern corresponding to a layer of the object being formed, as described above. The method 200 then concludes with fusing 230 the build material by exposing the fusing agent to a first wavelength band from a first irradiation source in the selected module. In this way, the desired object is formed layer-by-layer, as described above.

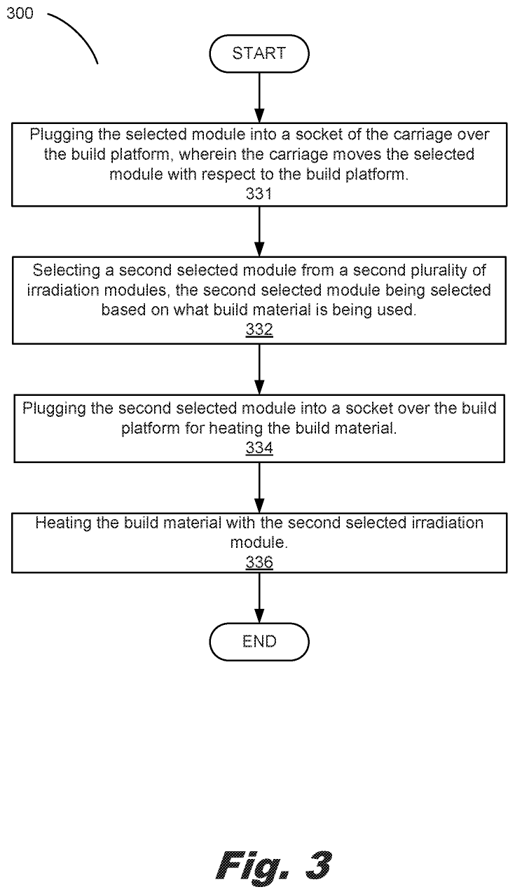

FIG. 3 is a flowchart showing additional aspects of an illustrative method 300 of operating an additive manufacturing device, consistent with the disclosed implementations. As noted above, FIG. 2 illustrated a method that enabled ready adaptation for different fusing agents. FIG. 3 illustrated a method that enables ready adaptation for different build materials. The methods of FIGS. 2 and 3 can be used together to tune for both a selected fusing agent and selected build material, or can be used separately.

As shown in FIG. 3, the method 300 includes plugging 331 the selected module into a socket of the carriage over the build platform, wherein the carriage moves the selected module with respect to the build platform. In this example, the selected module is able to move with the carriage to irradiate the build material and fuse the areas with the fusing agent applied. As discussed above, in other examples, the selected module is mounted such that the module does not move relative to the platform and irradiates the build material. In some examples, the static mounted module irradiates the whole of a layer of the build material simultaneously. In contrast, the carriage mounted module may irradiate a portion of the top layer of build material at a given time as the carriage moves relative to the layer of build material. Both of these approaches are viable ways to configure the irradiation module.

The method 300 also includes selecting 332 an irradiation module from a set of modules based on what build material is being used. In the specific example of FIG. 3, the method 300 may be practiced with the method 200 of FIG. 2. Accordingly, in FIG. 3, the actions include selecting 332 a second selected irradiation module from a second plurality of irradiation modules. The different modules of the second set emit different wavelength bands, each being tuned to best heat one of a number of different build materials. Depending on the physics of the different build materials, different wavelength bands will heat the build materials differently. Accordingly, the second selected module is selected based on what build material is being used.

Next, in FIG. 3, the method 300 includes plugging 334 the second selected module into a socket over the build platform for heating the build material. For example, each module may be configured with prongs that are received by interference fit in a socket of located over the build platform. In this way, the module is installed without needing tools. The module may be latched or otherwise secured in position and will receive power from the socket to emit the radiation for which it is tuned. In some examples, the radiation modules will each include Light Emitting Diodes (LEDs) as a radiation source. The emitted radiation may be in different portions of the electromagnetic spectrum as is best tuned for absorption by a corresponding build material. The second selected module may be mounted in a fixed relationship to the build layer.

The method 300 concludes with heating 336 the build material with the second selected irradiation module. Each irradiation module contains an irradiation source that will, when powered, emit radiation over a particular wavelength band. Thus, the second selected irradiation module is selected to emit a wavelength band that will be particularly effective or tuned to heating the build material being used. This will typically be a pre-heating cycle in which the build material of the uppermost layer on the build platform is heated prior to distributing fusing agent selectively in that build material layer.

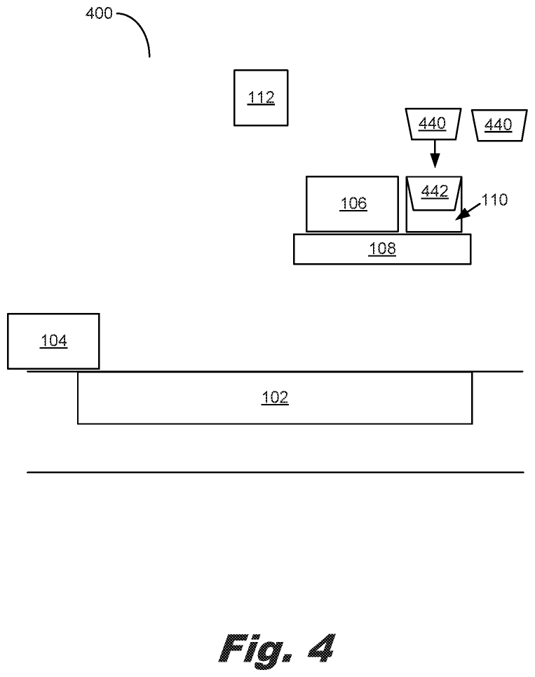

Like FIG. 1, FIG. 4 is a block diagram of an illustrative additive manufacturing device or system, consistent with the disclosed implementations. FIG. 4 also illustrates an additive manufacturing device that can be used to implement the method illustrated in FIG. 2.

As shown in FIG. 4, the additive manufacturing device 400 includes a build platform 102 for supporting successive, stacked layers of an object being formed. A spreader 104 is arranged with the build platform 102 for spreading successive layers of build material on the build platform 102.

A liquid dispenser 106 is arranged for selectively dispensing a liquid fusing agent into an uppermost layer of build material in a pattern corresponding to a layer of the object being formed. A carriage 108 moves the liquid dispenser 106 over the build platform 102.

A first irradiation source 110 having a first wavelength band is also disposed on the carriage 108. This irradiation source 110 is operated to irradiate the layer of build material as treated with the fusing agent. A second irradiation source 112 having a second wavelength band is disposed above the build platform 102 for heating the successive layers of build material on the build platform 102.

As shown in FIG. 4, the irradiation source 110 includes an irradiation module 442 that is one of a set 440 of multiple irradiation modules. Any of the set of modules 440 can be selected and plugged into the carriage 108, as described above. Each of the irradiation modules in the set 440 includes a radiation source that emits a different wavelength band in the electromagnetic spectrum. As discussed above with regard to FIG. 2, the selected module 442 is selected for having a wavelength band that matches the fusing agent being used by the liquid dispenser 106. In this way, a variety of different fusing agents can be used with the selected module 442 being selected and installed to match the fusing agent and effectively irradiate that fusing agent to coalesce or solidify the build material.

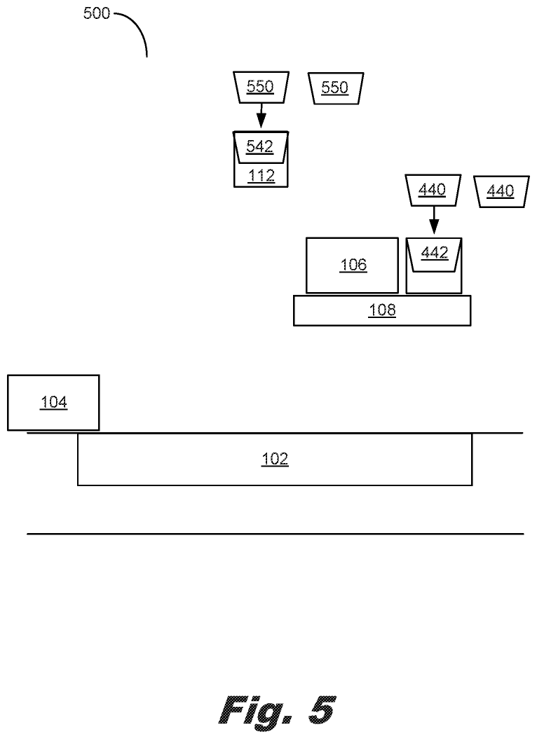

FIG. 5 is a block diagram of an illustrative additive manufacturing device 500 or system, consistent with the disclosed implementations. The device of FIG. 5 includes many of the same components as the example in FIG. 4.

Additionally, the device 500 of FIG. 5 includes a second set of irradiation modules 550 that includes multiple modules. One of the modules 542 is selected and installed in the radiation source 112 disposed over the build platform 102.

Any of the set of modules 550 can be selected and plugged into a socket of the irradiation source 112, as described above. Each of the irradiation modules in the set 550 includes a radiation source that emits a different wavelength band in the electromagnetic spectrum. As discussed above with regard to FIG. 3, the selected module 550 is selected for having a wavelength band that matches the build material being used on the build platform 102. Specifically, the second irradiation source 112, with the selected module 542, will pre-heat build material on the platform 102 to prepare the build material to receive a pattern of fusing agent for forming a layer of the object being manufactured.

With the ability to change out the irradiation module in the second irradiation source 112, a variety of different build materials can be used. As the build material being used changes, the selected module 542 is changed and installed to match the build material and effectively heat the build material to an optimal temperature to receive the fusing agent. In some examples, the build material includes a fusing agent mixed into the build material. This allows build materials to have additional absorption in a desired radiation band.

In some of the subsequent figures, filled areas under the emission curves exemplify approximate energy absorbed by the polymer build material powder and the respective fusing agent. These curves are used to estimate selectivity defined as the ratio of areas defined by the absorption curves and the respective emission curves. Change of the irradiation flux (dimmer or brighter irradiation) and change of the fusing agent concentration may impact these values. In addition, in the areas where fusing agent is present, both the absorption of fusing and of the polymer powder needs to be accounted separately.

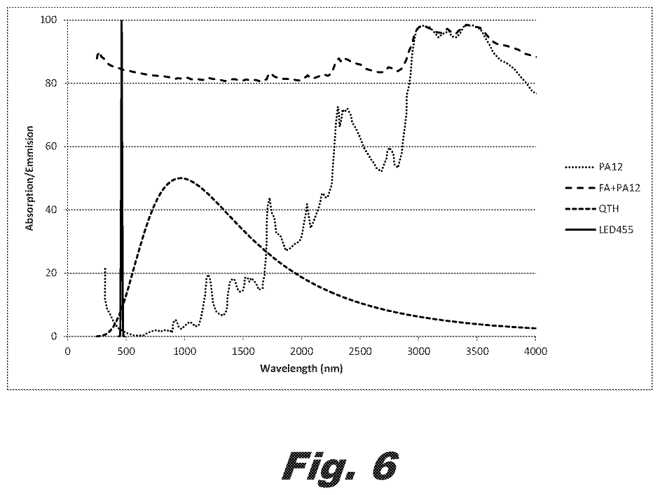

FIG. 6 shows the absorption profiles of a material and material-plus-fusing agent and emission profiles of a tungsten-halogen (QTH) lamp and a narrow wavelength lamp using LEDs. More specifically, FIG. 6 compares emission of the QTH lamp operating at 3000K (blackbody approximation) with the absorption of polyamide 12 (PA12) powder with and without carbon black fusing agent, the present Multijet Fusion (MJF) process. Printing selectivity is about 4 to 6 depending on the choice of QTH lamp temperature, and it may not be enough for some demanding 3D printed applications

The selectivity can be increased by separating powder heating done with an overhead tungsten-halogen lamp (3000K) lamp from the powder melting accomplished with a shorter wavelength narrow-band source mounted on the carriage and emitting in the range where polymer powder's absorption is minimal (approximate range between 600 nm and 340 nm to 500 nm depending on the selected polymer).

FIG. 6 shows an example of this solution involving use of a high power 455 nm LED array. Narrow-band irradiation can be accomplished with a variety of sources (filtered wide-band, lasers) but LEDs are particularly well suited due to their commercial availability, low cost, high efficiency and LED array design solutions providing large area, high power, and uniform irradiation. More specifically, FIG. 6 shows absorption and emission spectra of modified MJF: PA12 polymer, Fusing Agent (FA)=Carbon Black, radiation source 1 (stationary)=tungsten-halogen lamp (QTH) (3000K), radiation source 2 (carriage)=LED emitting at 455 nm (LED 455 nm). Estimated selectivity is about 15. Filled areas under the emission curves demonstrate approximate energy absorbed.

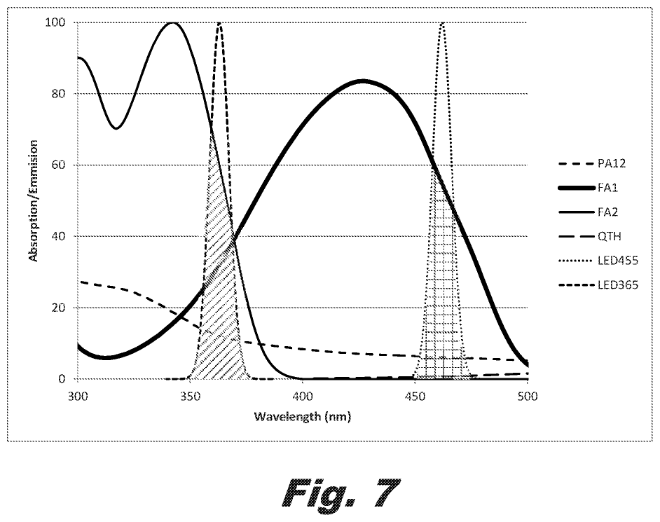

Further gains can be achieved when using fusing agent specifically matching the narrow-band emission. Use of visible mono-color irradiation source may produce colored parts, as shown in FIG. 7. Moving radiation source to near UV may allow fabrication of white parts assuming white polymer powder, as shown in FIG. 7. All FA absorption spectra shown here belong to previously disclosed agents, while emission spectra represent commercial LED products. FA1 is yellow 1 ink colorant (commercial dye), and FA2 is benzotriazole,

FIG. 7 shows the interaction of two fusing agents with selected LED sources. The sources show excellent absorption by the respective fusing agents allowing effective fusing with the fusing agent/LED source combo. More specifically, FIG. 7 shows absorption and emission spectra of within the MJF process in which Carbon Black FA is replaced by narrow-band absorbing FAs matching emission of the respective narrow-band source. This configuration assumes use of two radiation sources: broad-band QTH source for powder heating and narrow-band LED array for fusing FA coated regions. Two cases are shown: FA1 and LED emitting at 455 nm (LED455) produces yellow-colored parts, while FA2 and LED emitting at 365 nm (LED365) can produce white parts, when white powder is used. In the first case, estimated selectivity is about 35, while in the second case it is about 20.

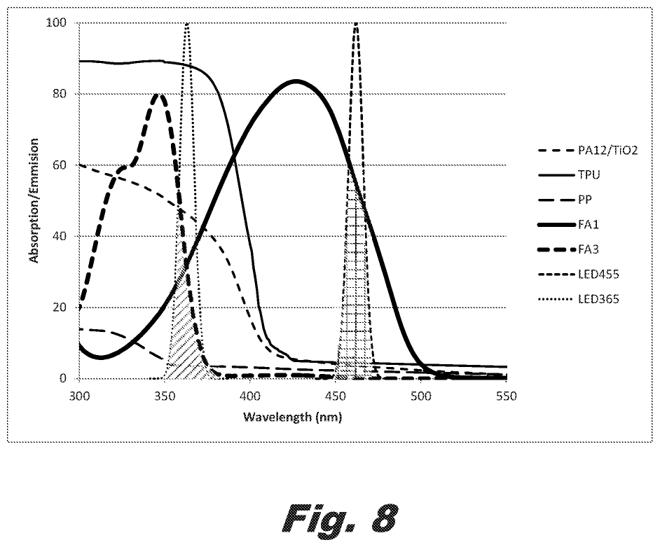

Choice of narrow band irradiation source and the corresponding FA may also depend on the printed polymer. For example, violet and near UV narrow-band fusing sources cannot be used when printing Thermoplastic Polyurethane (TPU) or titanium dioxide doped PA12 (PA12/TiO₂) due to excessive powder absorption in this range (FIG. 8). However, a LED array emitting at around 440 nm-470 nm may provide highly effective fusing of these powders.

Accordingly, FIG. 8 shows an example of a white and a yellow fusing agent with the respective LED sources. Strong absorption of the LED radiation is shown by the respective fusing agents. More specifically, FIG. 8 shows a comparison of printing scenario in which choice of narrow-band emitter and corresponding FA is determined by the used polymer building material. PA12/TiO₂ and TPU cannot be printed with UV emitter and respective FA due to excessive absorption, but blue (455 nm) source with the yellow absorber (FA1-yellow dye) can provide highly selective printing (selectivity˜25). For comparison, polypropylene (PP) weakly absorbing in near UV can be printed using LED emitting at 365 nm (LED365) and the corresponding colorless FA (FA3-pyridoxal NCI), selectivity exceeding 30).

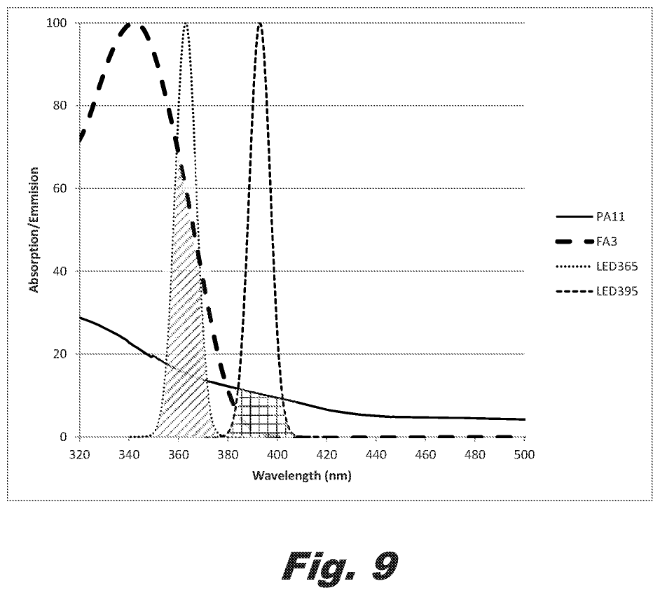

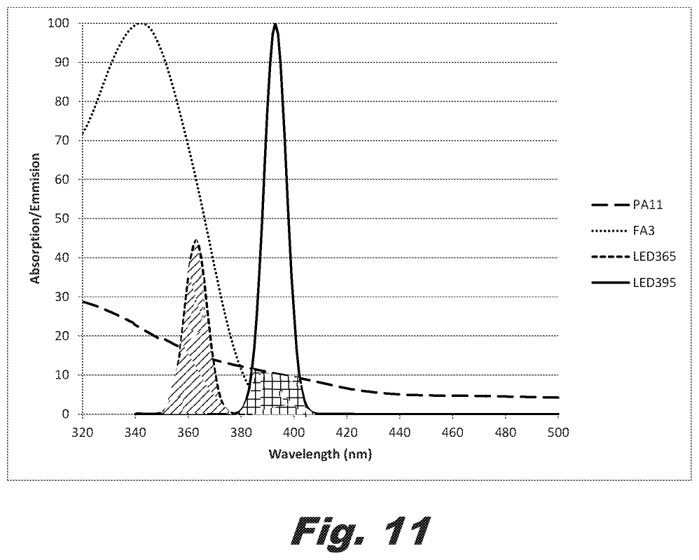

FIG. 9 shows heating the material (polyamide 11=PA 11) with an LED lamp and fusing with a second LED lamp and a fusing agent. More specifically, FIG. 9 shows yet another printing solution where narrow-band sources are used not only for fusing of the FA-coated regions but also for powder heating. In this case, one narrow-band source (LED emitting at 365 nm=LED365) combined with the appropriate FA (pyridoxal HCl=FA3) is still used for powder melting while powder heating is accomplished with another narrow band radiation source (LED emitting at 395 nm=LED395). The selectivity is approximately 8. In this case road-band QTH source is eliminated. Fusing and heating rate can be adjusted by appropriately adjusting irradiation intensities of both narrow-band sources (compare FIG. 9 and FIG. 11).

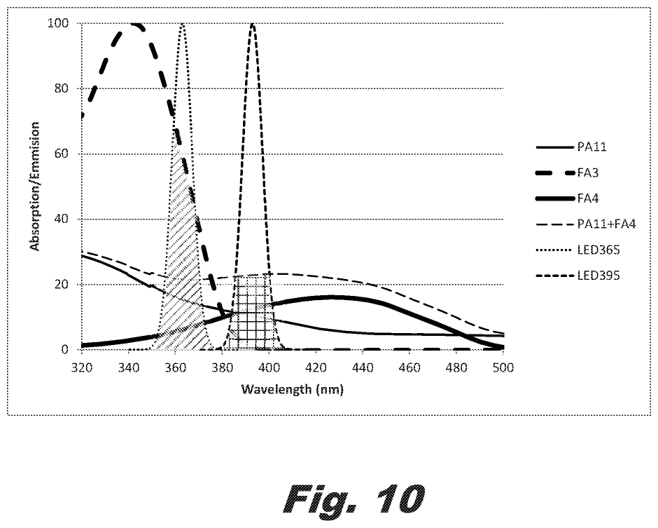

FIG. 10 shows using a fusing agent for both heating and fusing with LED lamps. The presence of the fusing agent helps with heating the material with the LED lamp. More specifically, FIG. 10 shows a printing scenario as in FIG. 9 except that an additional fusing agent (FA4) was printed in areas that are to remain unfused in order to increase powder heating.

FIG. 11 shows increasing the intensity of one of the LED lamps compared with the other to enhance heating of the material. More specifically, FIG. 11 shows a printing scenario as in FIG. 10 except that powder heating was increased by increasing intensity of the 395 nm LED rather than using additional fusing agent.

In one option, if the powder UV absorption is too weak an additional low-density FA matching the power heating narrow-band source may be applied to the regions remaining unfused, as shown in FIG. 10 where additional agent (yellow fusing agent=FA4) added to the powder can enhance UV absorption and powder heating. This additional agent can be dry blended into the powder before printing or printed at each subsequent layer either over the entire powder bed area or selectively in the regions where agent FA3 is absent. Each of these scenarios can provide different rate of heating and fusing. Table 1 shows examples of the commercial additives acting as UV absorbers when mixed into the powder.

In case when a broad IR emitting source (QTH) is employed heating rate of the powder can be increased by dry blending appropriate IR absorbing additive or selective printing IR absorbing ink like, for example, carbon black. Table 2 shows examples of dry blended commercial IR absorbers.

TABLE 1

| COLOR | TYPICAL USE/DELIVERY STATE |
|---|---|
| White | UV absorber for plastic and coatings |
| | for UV stabilization/dry powder |
| White | ZnO, different commercial grades, |
| | Sun protector/dry powder |
| Intense White | TiO₂, different commercial grade, can |
| | come premixed with polymer powder |
| Yellow | yellow pigment for injection |
| | plastics/dry powder |

TABLE 2

| COLOR | TYPICAL USE/DELIVERY STATE |
|---|---|
| Gray | laser marking/dry powder |
| Light Gray | laser marking/dry powder |
| Light Gray | laser marking/dry powder |
| Light Gray | marking/dry powder |
| Light Gray | laser welding, heating compound/dry powder |
| Dark | welding, heating compound/dry powder |

Described examples demonstrate multiple choices available when powder heating (with an overhead lamp) is separated from powder fusing (primarily with a lamp mounted on the moveable carriage). Full advantage of this solution becomes available when the described lamps are standardized in the form of easily replaceable modules, described above.

Fortunately, the LEDs arrays described can be easily packaged into thin, rectangular shapes matching space allowed for presently used MJF printer lamps. In addition, the proposed arrays emitting at different wavelength can be powered with the same low voltage power supply making switching between different modules simple.

In one example, the LED array includes two types of LEDs having different wavelengths. The two types of LEDs may be arranged in a checkerboard pattern in the LED array. In some examples, the second irradiation source and the first irradiation source are both housed in a selected module. The first irradiation source and second irradiation source may be two separate arrays or a single integrated array having LEDs of both frequencies. An integrated array may provide uniformity advantages over two separate arrays. Using two separate arrays in a single module may allow the arrays to be individually replaced. Accordingly, there are advantages to both approaches.

Thus, the proposed printer design can be easily reconfigured when changing printed polymer material by simply unplugging and removing radiation modules and replacing them with the modules matching printing requirement of the new polymer material (plus loading the appropriate fusing agents). It is also possible that a similar advantage can be realized when switching between different printed objects made of the same material. For example, one could consider the case of a high-volume production when all objects within print run are the same. Objects printed within the first run may not require high selectivity, but cost would need to be low, while objects printed in the second run may have details where high selectivity is needed, and cost is of lesser concern. This requirement may be addressed by selecting radiation sources and corresponding FAs appropriately satisfying needs of each runs and quickly switching them after the first run is completed.

Fusing experiments using UV sources and respective narrow-band fusing agents has shown that irradiation flux of about 5 W/cm 2 to 15 W/cm 2 lasting less than a second is sufficient to achieve complete melting of all presently considered polymers (PA12, PA12+additives, PA11, TPA=polyamide thermoplastic elastomer, TPU, PP). LEDs arrays (mostly GaN-based devices emitting wavelengths below 580 nm) are capable of satisfying and/or exceeding the needed radiation intensity.

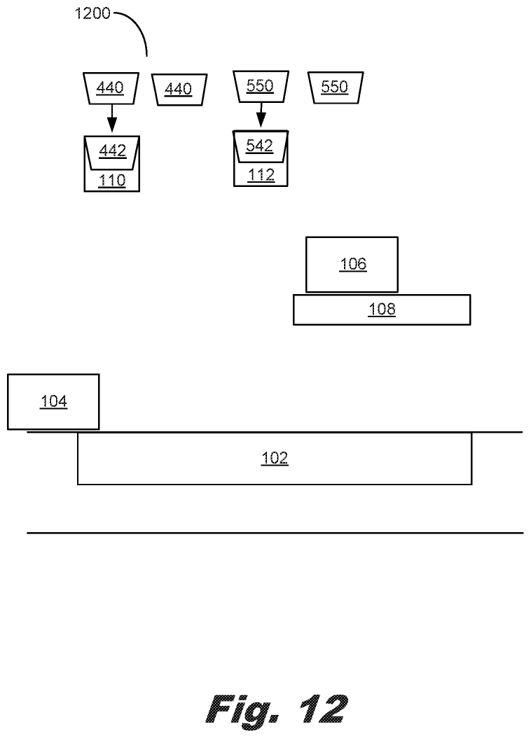

FIG. 12 is a block diagram of an illustrative additive manufacturing device or system 1200, consistent with the disclosed implementations. FIG. 12 includes a build platform 102, spreader 104, liquid dispenser and carriage 108 described above. FIG. 12 does not include an irradiation source 110 on the carriage 108. Instead, both irradiation sources 110 and 112 are mounted above the build platform 102. In some examples, the irradiation sources 110 and 112 are integrated into a single assembly. For example, the irradiation sources 110 and 112 may be arranged as a checkerboard pattern of LEDs of two different wavelengths. The irradiation sources 110 and 112 are modular allowing changeout of the irradiation.

The irradiation source 110 includes an irradiation module 442 that is one of a set 440 of multiple irradiation modules. Any of the set of modules 440 can be selected and plugged into a socket. Each of the irradiation modules in the set 440 includes a radiation source that emits a different wavelength band in the electromagnetic spectrum. As discussed above with regard to FIG. 2, the selected module 442 is selected for having a wavelength band that matches the fusing agent being used by the liquid dispenser 106. In this way, a variety of different fusing agents can be used with the selected module 442 being selected and installed to match the fusing agent and effectively irradiate that fusing agent to coalesce or solidify the build material.

The second irradiation source 112 similarly includes multiple modules in a set of modules 550. The second irradiation source may be selected from the set of modules 550 and installed above the build platform 102. The second irradiation source 112 provides heating of the build material. As discussed above, this heating may be augmented by inclusion of a fusing agent, either mixed in the build material or applied to the build material using the liquid dispenser 106. The second irradiation source 112 is selected from the set of modules 550 based on the build material and associated fusing agent, if any, used for heating the build material. In this example, there is no irradiation source 110 112 on the carriage 108.

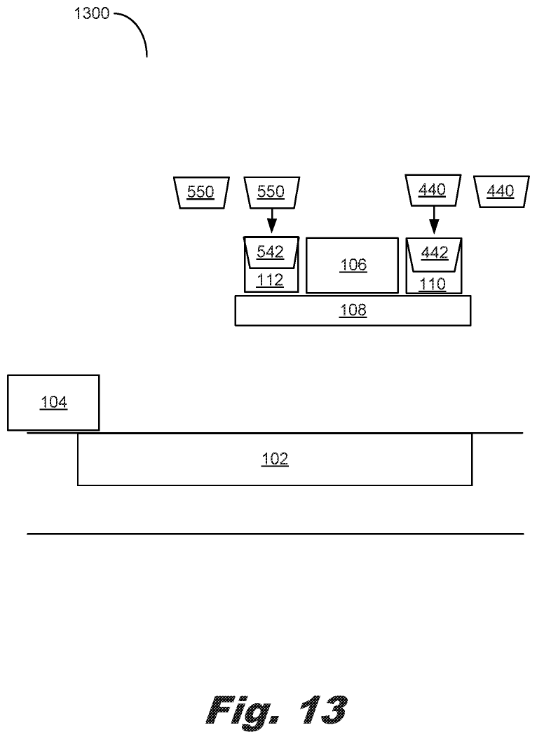

FIG. 13 shows is a block diagram of an illustrative additive manufacturing device or system 1300, consistent with the disclosed implementations. FIG. 13 includes a build platform 102, spreader 104, liquid dispenser and carriage 108 described above. FIG. 13 differs from previous figures in that the first irradiation source 110 and the second irradiation source 112 are both mounted on the carriage 108. As described previously, the carriage 108 moves across the build area of the build platform 102 allowing irradiation of the build material and deposition of a liquid, for example, a fusing agent. In this example, the irradiation sources 110 and 112 are modular as shown. This allows a user to select a first irradiation source 110 based on the fusing agent used and a second irradiation source 112 based on the build material. The first selected module 442 is provided to the first irradiation source 110 based on the fusing agent selected. The second selected module 542 is provided to the second irradiation source 112 based on the build material or the fusing agent used with the build material. The build material may include fusing agent mixed into the build material. The build material may have fusing agent deposited onto the build material to enhance heating of the build material. In this example, there is no fixed irradiation source 110 112, instead all the irradiations sources 110 and 112 are mounted on the carriage 108.

The preceding description has been presented only to illustrate and describe examples of the principles described. This description is not intended to be exhaustive or to limit these principles to any precise form disclosed. Many modifications and variations are possible in light of the above teaching.

What is claimed is:

1. An additive manufacturing device comprising:
a build platform for supporting successive, stacked layers of an object being formed;
a spreader for spreading successive layers of build material on the build platform;
a liquid dispenser for selectively dispensing a liquid fusing agent into an uppermost layer of build material in a pattern corresponding to a layer of the object being formed;
a carriage for moving the liquid dispenser over the build platform;
a first irradiation source to irradiate the object being formed, having a first wavelength band, the first wavelength band being tuned for absorption by the fusing agent; and
a second irradiation source having a second wavelength band disposed above the build platform for heating the successive layers of build material on the build platform;
wherein the first wavelength band does not overlap the second wavelength band.

2. The additive manufacturing device of claim 1, further comprising a first plurality of irradiation modules each comprising an irradiation source;
wherein the carriage comprises a socket to receive any of the first plurality of irradiation modules as the first irradiation source; and
wherein each of the first plurality of irradiation modules has a wavelength band tuned to a different fusing agent.

3. The additive manufacturing device of claim 2, further comprising a second plurality of irradiation modules;
wherein the second irradiation source comprises a socket to receive any of the second plurality of irradiation modules;
wherein each of the second plurality of irradiation modules has a wavelength band tuned to a different build material.

4. The additive manufacturing device of claim 2, wherein each of the first plurality of irradiation modules comprises a light emitting diode (LED) radiation source.

5. The additive manufacturing device of claim 1, further comprising a plurality of irradiation modules;
wherein the second irradiation source comprises a socket to receive any of the plurality of irradiation modules;
wherein each of the plurality of irradiation modules has a wavelength band tuned to a different build material.

6. The additive manufacturing device of claim 1, wherein the first irradiation source is disposed on the carriage.

7. An additive manufacturing method, the method comprising:
selecting one of a plurality of irradiation modules based on a selected module having a wavelength band tuned for absorption by a fusing agent to be used to form an object by additive manufacture;
plugging the selected module into a socket over the build platform;
supporting successive, stacked layers of the object being formed on the build platform;
using a liquid dispenser mounted on the carriage, selectively dispensing the fusing agent into an uppermost layer of build material in a pattern corresponding to a layer of the object being formed; and
fusing the build material by exposing the fusing agent to a first wavelength band from a first irradiation source in the selected module.

8. The method of claim 7, further comprising plugging the selected module into a socket of the carriage over the build platform, wherein the carriage moves the selected module with respect to the build platform.

9. The method of claim 7, further comprising heating the build material with a second irradiation source emitting a second wavelength band, wherein the first wavelength band does not overlap the second wavelength band.

10. The method of claim 9, wherein the second irradiation source and the first irradiation source are both housed in the selected module.

11. The method of claim 9, further comprising:
selecting a second selected module from a second plurality of irradiation modules, the second selected module being selected based on what build material is being used; and
plugging the selected module into a socket over the build platform for heating the build material.

12. An additive manufacturing device comprising:
a build platform for supporting successive, stacked layers of an object being formed;
a spreader for spreading successive layers of build material on the build platform;
a liquid dispenser for selectively dispensing a liquid fusing agent into an uppermost layer of build material in a pattern corresponding to a layer of the object being formed;
a plurality of irradiation modules each comprising a radiation source with a wavelength band tuned for absorption by a different fusing agent;
a carriage for moving the liquid dispenser over the build platform, wherein the carriage comprises a socket to receive any of the plurality of irradiation modules as a first irradiation source; and
a second irradiation source disposed above the build platform for heating the successive layers of build material on the build platform.

13. The additive manufacturing device of claim 12, wherein a wavelength band of the first irradiation source does not overlap a wavelength band of the second irradiation source.

14. The additive manufacturing device of claim 12, further comprising a second plurality of irradiation modules;
wherein the second irradiation source comprises a socket to receive any of the second plurality of irradiation modules; and
wherein each of the second plurality of irradiation modules has a wavelength band tuned to a different build material.

15. The additive manufacturing device of claim 12, wherein each of the plurality of irradiation modules comprises a light emitting diode (LED) radiation source.
